(19) United States
(12) Patent Application Publication
(10) Pub. No.: US 2008/0249907 A1
(43) Pub. Date: Oct. 9, 2008

(54) Novel Method for Paying a Mortgage

(76) Inventor: Raffi Sadejyan, Sherman Oaks, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/697,324

(22) Filed: Apr. 6, 2007

(51) Int. Cl. G06Q 40/00

(52) U.S. Cl. 705/35

(57) ABSTRACT

A method for a mortgage to skip a monthly payment per year comprising collecting twenty four payments from a mortgagee over an eleven month period, placing the payments in a predetermined account and timely paying the mortgagor monthly over a twelve month period from the predetermined account.

### FIELD OF THE INVENTION

The present invention is directed to the field of mortgage payment systems and methods.

### BACKGROUND OF THE INVENTION

Within the last fifteen (15) years there have been dozens of new methods for financing home ownership. These include Adjustable Rate Mortgages, Graduated Payment Mortgages, Option Payment ARMs and buy down loans. So-called “Reverse” mortgages have recently gained popularity. All of these programs are designed to facilitate the borrower's ability to qualify for a loan and to make the monthly payments.

There have been a number of patents directed to mortgage related systems and methods. U.S. Pat. No. 5,966,700 to Gould is directed towards a computer system for managing the allocation of mortgage pool risk between a mortgage originator and a funding institution. The mortgage originator issues a mortgage and the funding institution agrees to assume certain risks such as interest rate and credit risk for the mortgage up to a certain percentage. The mortgage originator and the funding institution enter into a Master Commitment agreement which has an overall credit enhancement value for mortgage funding by the mortgage originator. The system has an input device capable of receiving mortgage data from the mortgage originator. A memory has a database storing the data relating to the mortgage loan, Master Commitment, financial institution and rate and fees. A processor calculates a credit enhancement value as a function of the probability of foreclosure and the severity of loss indicated by mortgage data. An output device produces a delivery commitment in which the mortgage originator assumes obligation for losses up to the credit enhancement value and the funding institution assumes obligation for additional losses.

U.S. Pat. No. 5,991,745 to Kiritz is directed towards a system and process of calculating monetary payments by a lender to a borrower based on the value of an asset using at least one of a plurality of constants stored in look-up tables. The process includes inputting borrower information such as borrower birthdate or age. Property specific information is input, such as appraised property value. Equity share information is also input. With the Equity share information and borrower age, the process looks-up a tenure conversion factor from a look-up table. The loan type is input as one of tenure, line of credit, and modified tenure and appropriate variables are set accordingly. The principal limit factor is read from a look-up table and the original principal limit is calculated to be equal to the principal limit factor multiplied by the appraised property value. Next the net principal limit is calculated as the original principal limit minus costs. The loan is then calculated—if tenure, then the monthly payment equals net principal limit times tenure conversion factor, if line of credit, then the net principal limit equals the line of credit, and if modified tenure, then net line of credit equals net principal limit minus (monthly payment divided by tenure conversion factor), when a monthly payment amount was requested or monthly payment equals (net principal limit minus net line of credit) multiplied by tenure conversion factor when a net line of credit was requested.

U.S. Pat. No. 6,345,262 to Madden is directed towards a system and method for implementing a mortgage plan. Data is input to a computer system regarding the mortgage terms, and the computer system is used to prepare a mortgage document which creates an equity participation mortgage obligation in which the lender shares in a predetermined percentage of realized appreciation on the subsequent sale of the asset which is the subject of the mortgage. In a particularly preferred embodiment, this mortgage plan can provide the borrower with an interest-free loan, a faster amortization schedule, and a larger, yet more affordable mortgage. The lender also receives substantial benefits, including the potential for a return which exceeds conventional mortgage rate returns, insulation from risk against interest rate fluctuation, and preferred tax treatment in the form of capital gains tax rates paid only upon the subsequent sale of the mortgaged asset. No maturity date need be specified for the mortgage; rather, it may be tied to the ultimate sale of the asset subject to the mortgage.

U.S. Patent Application No. 20070067234 to Beech is directed towards a system and method are provided for qualifying and selecting mortgage loans for a borrower. The method includes the operation of collecting mortgage loan information from the borrower. A further operation is obtaining credit information for the borrower via a network based on the mortgage loan information. The combined mortgage loan information and credit information can be compared with the conditions of a plurality of mortgage loan programs offered by a mortgage supplier. The comparison can generate a qualified active listing of mortgage loan programs from a plurality of mortgage loan programs.

U.S. Patent Application No. 20060080246 to Wyckoff discloses a program for encouraging homebuyers to purchase more efficient HVAC equipment at the time they purchase an existing house is described. The purchase price of the HVAC equipment is included in the mortgage loan. The overall monthly cost of the mortgage payment and heating and cooling costs is lowered for any given house. The program is marketed through a real estate agent working closely with a HVAC supplier. A central control entity may oversee the process, provide standardized forms, and locate appropriate installers.

U.S. Patent Application No. 20050114259 to Almeida discloses a mortgage option method providing a way that applicants wishing to take advantage of low mortgage interest rates, but who, for whatever reason, are unable or unwilling to initiate the application process at the present time, can obtain a right to the low mortgage rate at some time in the future when mortgage rates have increased. Designed for either the residential or commercial real estate market, the method allows customers to lock-in a mortgage at the then current rate for up to four years by paying a nonrefundable up-front premium. The mortgage option may be exercised at any time during the option term, at a rate lower than the prevailing rates.

While there have been a number of inventions directed towards mortgage loans, none of the prior art are directed to systems which enable borrowers to selectively avoid a monthly payment each year. Such a system would provide flexibility for a mortgagee.

It is an object of the present invention to provide a mortgage system which enables the mortgagee to skip one monthly payment per year.

It is a further object of the present invention to provide a mortgage with the ability to selectively skip a monthly payment based upon the cash flow desires of the borrowers.

These and other objects of the present invention will become apparent from the detailed description which follows.

### SUMMARY OF THE INVENTION

In a first embodiment, the present invention is a method for a mortgage to skip a monthly payment per year comprising collecting twenty four payments from a mortgagee over an eleven month period, placing the payments in a predetermined account and timely paying the mortgagor monthly over a twelve month period from the predetermined account.

In accordance with a further aspect, the present invention is a method for a mortgagee to skip a monthly payment per year comprising collecting two bi-monthly payments from a mortgagee over an eleven month period, each bi-monthly payment corresponding to one half of the mortgagee's monthly payment, collecting two additional bimonthly payments according to a predetermined formula, placing all of the collected monies into a predetermined account and timely paying the mortgagor the appropriate monthly payment over a twelve month period from the predetermined account.

In yet a further embodiment, the invention is a method for a mortgagee to skip a monthly payment per year comprising collecting bi-monthly payments from a mortgagee over an eleven month period, each bimonthly payment corresponding to one half of the mortgagee's monthly payout, collecting two additional bimonthly payments according to a predetermined formula, placing all of the collected monies into a predetermined escrow account and timely paying the mortgagor the appropriate monthly mortgage amount over a twelve month period from the predetermined escrow account.

### BRIEF DESCRIPTION OF THE FIGURES

FIG. 1 is a flow chart of the operation of the present invention.

FIG. 2 is a second flow chart illustrating the operation of the invention.

### DESCRIPTION OF THE PREFERRED EMBODIMENT

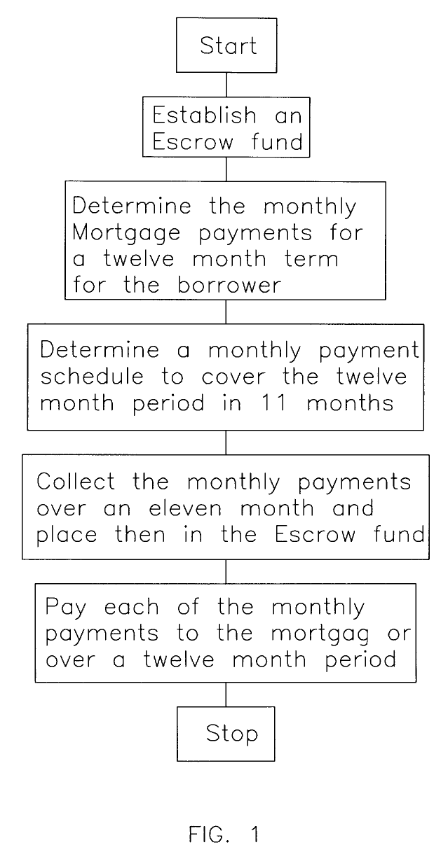

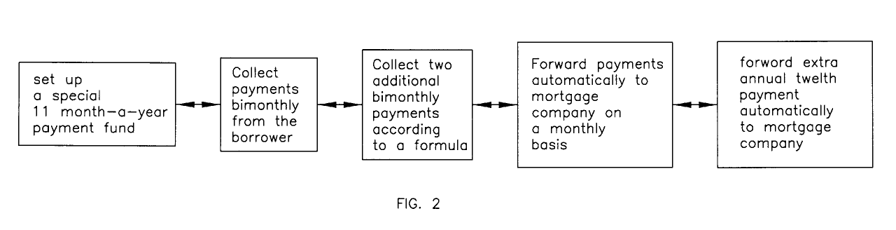

The invention is described with reference to the enclosed Figures wherein the same numbers are used where applicable. Referring to FIGS. 1 and 2, the present invention is a novel mortgage loan payment method wherein the mortgagee has the ability, at the time of original financing or refinancing to have a third-party mortgage servicer create a specialized “sinking fund” or “payment fund”. Typically the fund will be an escrow or trust account.

In operation, the fund will collect 22 pre-portioned bi-monthly mortgage payments, which are paid bimonthly over an eleven month period to the mortgager. Additional half payments are collected during two of the months (excluding the free month). The method to collect these additional payments can vary. The borrower may select two arbitrary dates for the additional two payments to be made. The payouts can be made on a selected date such as the “fifth” Thursday or Friday of two different months. Hence, the entire 12 month obligation of the borrower/mortgagee (24 payments) is collected over 11 months.

As noted, each payment made by the mortgagee is equal one half of the mathematically calculated monthly mortgage payment. All payments are then held in the escrow or similar trust account under the control of the servicing organization. In a preferred embodiment, this payment will then be automatically forwarded to the mortgage holder via the Federal Reserve Systems Automated Clearing House (ACH) network.

In one embodiment, because at least two (2) calendar months have five (5) Thursdays or Fridays compared to the usual four (4) in other months, a twelfth full mortgage payment comprising two half payments is collected on two of these “fifth” Thursdays or Fridays before the twelfth calendar month is reached. This twelfth payment is used to cover the once-a-year payment that the homeowner chooses to “skip”. In a preferred embodiment, the skip monthly will typically be December. It is to be appreciated that this month can be altered.

The “skipped” payment is still tendered to the mortgage lender as a regular scheduled payment, but due to the special payment fund, the homeowner does not need to send this payment to the lender. The special payment fund handles the tendering of the “skip” payment.

While the invention has been described with reference to the above discussed preferred embodiment, the true nature and scope of the invention is to be determined with reference to the attached claims.

I claim:

1. A method for a mortgage to skip a monthly payment per year comprising:
collecting twenty four payments from a mortgagee over an eleven month period;
placing the payments in a predetermined account; and
timely paying the mortgagor monthly over a twelve month period from the predetermined account.

2. A method for a mortgagee to skip a monthly payment per year comprising:
collecting two bimonthly payments from a mortgagee over an eleven month period, each bimonthly payment corresponding to one half of the mortgagee's monthly payment;
collecting two additional bimonthly payments according to a predetermined formula;
placing all of the collected monies into a predetermined account; and
timely paying the mortgagor the appropriate monthly payment over a twelve month period from the predetermined account.

3. A method for a mortgagee to skip a monthly payment per year comprising:
collecting bimonthly payments from a mortgagee over an eleven month period, each bimonthly payment corresponding to one half of the mortgagee's monthly payout;
collecting two additional bimonthly payments according to a predetermined formula;
placing all of the collected monies into a predetermined escrow account; and
timely paying the mortgagor the appropriate monthly mortgage amount over a twelve month period from the predetermined escrow account.
